(19) United States
(12) Patent Application Publication
(10) Pub. No.: US 2013/0012629 A1
(43) Pub. Date: Jan. 10, 2013

(54) META-TYPE WHOLLY AROMATIC POLYAMIDE FIBER

(75) Inventors: Kotarou Takiue, Iwakuni-shi (JP); Tomoyoshi Chiba, Hiroshima-shi (JP)

(73) Assignee: TEIJIN TECHNO PRODUCTS LIMITED, Osaka-shi, Osaka (JP)

(21) Appl. No.: 13/636,036

(22) PCT Filed: Mar. 26, 2010
(86) PCT No.: PCT/JP2010/055359

§ 371 Date: Sep. 19, 2012

(51) Int. Cl. C08L 77/00; C08K 5/3415

(52) U.S. Cl. 524/104

(57) ABSTRACT

There is provided a novel meta-type wholly aromatic polyamide fiber which has a high breaking strength and can inhibit coloration or discoloration under high temperatures, while retaining latent properties of the meta-type wholly aromatic polyamide fiber, such as heat resistance and flame retardancy. Components or conditions of a coagulation bath are appropriately controlled so as to give a dense coagulation state having no skin-core structure, plastic stretching is performed within a specific ratio, and further, subsequent heat stretching conditions are made proper, thereby obtaining a meta-type wholly aromatic polyamide fiber containing substantially no layered clay mineral, in which the amount of solvent remaining in the fiber is 1.0% by mass or less based on the whole fiber, and the breaking strength of the fiber is from 4.5 to 6.0 cN/dtex.

### TECHNICAL FIELD

The present invention relates to a meta-type wholly aromatic polyamide fiber. More specifically, the present invention relates to a novel meta-type wholly aromatic polyamide fiber which contains no layered clay mineral, is excellent in mechanical characteristics and can provide a high-quality product.

### BACKGROUND ART

It has been well known that wholly aromatic polyamides produced from aromatic diamines and aromatic dicarboxylic acid dichlorides are excellent in heat resistance and excellent in flame retardancy. Further, it has also been known that these wholly aromatic polyamides are soluble in amide-based solvents, and fibers can be obtained from these polymer solutions by methods such as dry spinning, wet spinning and semi-dry semi-wet spinning.

Of such wholly aromatic polyamides, a meta-type wholly aromatic polyamide fiber (hereinafter abbreviated as “meta-aramid” in some cases) represented by poly-m-phenylene isophthalamide is particularly useful as a heat resistant and flame retardant fiber. As methods for producing such a meta-aramid fiber, the following two methods of (a) and (b) have been employed. Furthermore, as methods for producing the meta-aramid fiber other than these methods, methods such as (c) to (e) have also been proposed.

(a) A method for producing a meta-aramid fiber by subjecting m-phenylenediamine and isophthaloyl chloride to low temperature solution polymerization in N,N-dimethylacetamide to prepare a poly-m-phenylene isophthalamide solution, thereafter, neutralizing hydrochloric acid by-produced in the solution with calcium hydroxide to obtain a polymer solution containing calcium chloride, and dry-spinning the resulting polymer solution (patent document 1: JP-B-35-14399).

(b) A method of isolating a powder of a poly-m-phenylene isophthalamide polymer by bringing an organic solvent system (for example, tetrahydrofuran) which is not a good solvent for a product polyamide comprising a m-phenylenediamine salt and isophthaloyl chloride into contact with an aqueous solution system containing an inorganic acid receiving agent and a soluble neutral salt (patent document 2: JP-B-47-10863), and re-dissolving this polymer powder in an amide-based solvent, followed by wet-spinning in an aqueous coagulation bath containing an inorganic salt (patent document 3: JP-B-48-17551).

(c) A method for producing a formed article such as a fiber by a wet-forming method from a meta-aramid solution containing no inorganic salt or a slight amount (2 to 3%) of lithium chloride prepared by dissolving a meta-aramid synthesized by a solution polymerization method in an amide-based solvent (patent document 4: JP-A-50-52167).

(d) A method of extruding a meta-aramid polymer solution obtained by solution polymerization in an amide-based solvent and containing calcium chloride, formed by neutralization with calcium hydroxide, calcium oxide or the like, and water into a gas through orifices to allow it to pass through the gas, thereafter, introducing it into an aqueous coagulating bath, and then, allowing it to pass through an aqueous solution of an inorganic salt such as calcium chloride to form the solution into a fibrous material (patent document 5: JP-A-56-31009).

(e) A method of spinning a meta-aramid polymer solution obtained by solution polymerization in an amide-based solvent and containing calcium chloride, formed by neutralization with calcium hydroxide, calcium oxide or the like, and water into an aqueous coagulation bath containing calcium chloride in a high concentration through orifices to form the solution into a fibrous material (patent document 6: JP-A-8-074121, patent document 7: JP-A-10-88421, and the like).

However, according to the above-mentioned method (a), in the fibrous polymer solution spun from a spinning die, the solvent is vaporized and dried from the vicinity of a surface of the fibrous material formed because of dry spinning, so that a dense and firm skin layer is formed on a surface of the fiber. Accordingly, it has been difficult to remove sufficiently the residual solvent, even when the fibrous material is continuously rinsed by water washing or the like. Thus, yellowing has occurred in the fiber obtained by the method (a) at the time of use under a high-temperature atmosphere due to the solvent remaining in the fiber. For this reason, it is necessary to avoid heat treatment at high temperatures. As a result, there has been a problem that it is difficult to increase the strength.

On the other hand, in the above-mentioned methods (b) to (e), evaporation of the solvent in the spinning step does not occur because of wet spinning. However, when the polymer formed into fibrous form is introduced into the aqueous coagulation bath or the aqueous coagulation bath containing the inorganic salt in a high concentration, the solvent is released from the vicinity of a surface of the fibrous polymer into the aqueous coagulation bath, and simultaneously, water contained in the coagulation bath liquid enters the inside of the fibrous material from the vicinity of a surface of the coagulated fibrous material to form a firm skin layer. For this reason, it has been difficult to remove sufficiently the solvent remaining in the fiber, and coloration and discoloration (particularly yellowing) under a high-temperature atmosphere due to the residual solvent have not been avoided, similarly to the fiber formed by the dry spinning method. Accordingly, also for the fiber obtained by the methods (b) to (e), it is necessary to avoid heat treatment at high temperatures, and there has been still left the problem that it is difficult to increase the strength of the fiber.

Further, patent document 8 (JP-A-2001-348726) proposes a method of coagulating a meta-aramid solution to a fibrous material having pores, thereafter, heat stretching the fibrous material in the air while containing a coagulation liquid in the pores or in a state where a plasticizing liquid is allowed to be contained in the pores, and successively heating the fibrous material while containing the coagulation liquid or the like in the pores, followed by heat treatment.

According to the method described in patent document 8, in the step where the meta-aramid solution is formed into the fibrous material by coagulation, there is obtained the porous fibrous material having substantially no skin layer on a surface thereof. However, when the porous fibrous material containing the plasticizing liquid is heated, it becomes significantly difficult to successively remove the solvent. As a result, also for the fiber obtained by this method, coloration and discoloration (particularly yellowing) under a high-temperature atmosphere due to the residual solvent have not been avoided. Accordingly, also for the fiber obtained by the method described in patent document 8, it is necessary to avoid heat treatment at high temperatures, and there has been still left the problem that it is difficult to increase the strength of the fiber.

Patent documents 9 and 10 describe meta-type wholly aromatic polyamide fibers containing a layered clay mineral. The meta-type wholly aromatic polyamide fibers described in patent documents 9 and 10 become fibers having a low residual solvent amount by blending of the layered clay material. However, these layered clay mineral-containing meta-type wholly aromatic polyamide fibers are low in insulation properties which characterize a meta-type aromatic polyamide, and the layered clay mineral drops off and scatters at the time of cutting processing or twisting processing in some cases. Accordingly, further improvement has been required from the viewpoints of improvement of insulation properties and prevention of dropping off and scattering of the layered clay mineral.

Patent document 11 describes a meta-type wholly aromatic polyamide fiber excellent in high-temperature processability which is characterized in that the amount of solvent remaining in the fiber is 1.0% by weight or less, that the dry heat shrinkage percentage at 300° C. is 3% or less, and that the breaking strength of the fiber is 3.0 cN/dtex or more . However, in patent document 11, a fiber having a breaking strength of 4.5 cN/dtex or more is not reported, and further improvement has been required with respect to such high breaking strength and dimensional stability as required for base fabrics use of high-temperature filters, rubber reinforcement use and the like.

### PRIOR-ART DOCUMENTS

### Patent Documents

[Patent Document 1] JP-B-35-14399

[Patent Document 2] JP-B-47-10863

[Patent Document 3] JP-B-48-17551

[Patent Document 4] JP-A-50-52167

[Patent Document 5] JP-A-56-31009

[Patent Document 6] JP-A-8-074121

[Patent Document 7] JP-A-10-88421

[Patent Document 8] JP-A-2001-348726

[Patent Document 9] JP-A-2007-254915

[Patent Document 10] JP-A-2007-262589

[Patent Document 11] WO-A-2007/089008

### DISCLOSURE OF THE INVENTION

### Problems That The Invention Is To Solve

The present invention has been made in view of the above-mentioned conventional art, and an object thereof is to provide a novel meta-type wholly aromatic polyamide fiber which has a high breaking strength and can inhibit coloration or discoloration under high temperatures, while retaining latent properties of the meta-type wholly aromatic polyamide fiber, such as heat resistance and flame retardancy.

### Means for Solving the Problems

In order to solve the above-mentioned problem, the present inventors have made intensive studies. As a result, it has been found out that the above-mentioned problem can be solved by appropriately controlling components or conditions of a coagulation bath so as to give a dense coagulation state having no skin-core structure, performing plastic stretching within a specific ratio, and further making subsequent heat stretching conditions proper, thus leading to the completion of the present invention.

That is to say, the present invention is a meta-type wholly aromatic polyamide fiber containing substantially no layered clay mineral, and a meta-type wholly aromatic polyamide fiber in which the amount of solvent remaining in the fiber is 1.0% by mass or less based on the whole fiber, and the breaking strength of the fiber is from 4.5 to 6.0 cN/dtex.

Here, the meta-type wholly aromatic polyamide fiber of the present invention preferably has a dry heat shrinkage percentage at 300° C. of 5.0% or less.

Further, the meta-type wholly aromatic polyamide fiber of the present invention preferably has an initial elastic modulus of 800 to 1,500 cN/mm².

### Advantages Of The Invention

According to the present invention, there is provided a meta-type wholly aromatic polyamide fiber (particularly a poly-m-phenylene isophthalamide-based fiber) which is good in mechanical characteristics, heat resistance and the like, has an extremely slight amount of solvent remaining in the fiber, and contains substantially no layered clay mineral. The fiber of the present invention has strength in addition to latent properties of the meta-type wholly aromatic polyamide fiber, such as heat resistance and flame retardancy, and can inhibit coloration or discoloration (particularly yellowing) of the fiber or a fiber product in processing and usage under high temperatures. Accordingly, the fiber of the present invention becomes usable even in fields in which the conventional meta-type wholly aromatic polyamide fiber cannot be used, and the industrial value thereof is extremely high.

### MODE FOR CARRYING OUT THE INVENTION

<Meta-Type Wholly Aromatic Polyamide Fiber>

The meta-type wholly aromatic polyamide fiber of the present invention has the following specific physical properties. The physical properties, constitution, production method and the like of the meta-type wholly aromatic polyamide fiber of the present invention will be described below.

[Physical Properties of Meta-Type Wholly Aromatic Polyamide Fiber]

The meta-type wholly aromatic polyamide fiber of the present invention has a breaking strength within the predetermined range and has an extremely small amount of solvent remaining in the fiber. Specifically, the meta-type wholly aromatic polyamide fiber of the invention is a meta-type wholly aromatic polyamide fiber containing substantially no layered clay mineral, the amount of solvent remaining in the fiber is 1.0% by mass or less, and the breaking strength of the fiber is from 4.5 to 6.0 cN/dtex. For this reason, the meta-type wholly aromatic polyamide fiber of the present invention can inhibit coloration or discoloration of the fiber or the product in processing and usage under high temperatures.

[Residual Solvent Amount]

A meta-type wholly aromatic polyamide fiber is generally produced from a spinning stock solution formed by dissolving a polymer in an amide-based solvent, so that the solvent inevitably remains in the fiber. However, in the meta-type wholly aromatic polyamide fiber of the present invention, the amount of solvent remaining in the fiber is 1.0% by mass or less based on the mass of the fiber. It is essentially 1.0% by mass or less, and more preferably 0.5% by mass or less. Particularly preferably, it is from 0.01 to 0.1% by mass.

When the solvent remains in the fiber in an amount exceeding 1.0% by mass based on the mass of the fiber, it is unfavorable because yellowing is liable to occur and the strength is significantly decreased in the case of processing or usage under such a high temperature atmosphere as exceeding 200° C.

In the present invention, in order to decrease the residual solvent amount in the meta-type wholly aromatic polyamide fiber to 1.0% by mass or less, plastic stretching is performed within the specific ratio range, and further, subsequent heat stretching conditions are made proper.

Incidentally, the term “the amount of solvent remaining in the fiber” in the present invention means the value obtained by the following method.

(Measuring Method of Residual Solvent Amount)

The fiber is sampled at an exit side of a rinsing step. Then, the fiber is centrifuged (number of revolutions: 5,000 rpm) for 10 minutes, and the fiber mass (M1) at this time is measured. This fiber is boiled in M2 g by mass of methanol for 4 hours to extract the amide-based solvent and water in the fiber. The fiber after extraction is dried under an atmosphere of 105° C. for 2 hours, and the fiber mass (P) after drying is measured. Further, the mass concentration (C) of the amide-based solvent contained in an extract is determined with a gas chromatograph.

The amount of solvent remaining in the fiber (amide-based solvent mass) N% is calculated by the following equation, using M1, M2, P and C described above.

N=[C/100]×[(M1+M2−P)/P]×100

[Breaking Strength]

The meta-type wholly aromatic polyamide fiber of the present invention has a breaking strength ranging from 4.5 to 6.0 cN/dtex. It is essentially within the range of 4.5 to 6.0 cN/dtex, preferably within the range of 5.5 to 6.0 cN/dtex, more preferably within the range of 5.7 to 6.0 cN/dtex, and still more preferably within the range of 5.8 to 6.0 cN/dtex. When the breaking strength is less than 4.5 cN/dtex, the strength of the resulting product is low. Accordingly, it cannot unfavorably resist the use in its applications. On the other hand, when the breaking strength exceeds 6.0 cN/dtex, the elongation substantially decreases to cause such a problem that handling of the product becomes difficult.

In order to adjust the “breaking strength” within the above-mentioned range in the meta-type wholly aromatic polyamide fiber of the present invention, components or conditions of a coagulation bath are appropriately controlled so as to give a dense coagulation state having no skin-core structure, plastic stretching is performed within a specific ratio, and further, subsequent heat stretching conditions are made proper.

Incidentally, the term “breaking strength” in the present invention means the value obtained by performing measurement, based on JIS L 1015, using a measuring instrument (model number 5565) manufactured by Instron Corp., under the following conditions:

(Measuring Conditions)

Clamp distance: 20 mm

Initial tension: 0.044 cN (1/20 g)/dtex

Tensile speed: 20 mm/min

[Breaking Elongation]

The meta-type wholly aromatic polyamide fiber of the present invention has a breaking elongation of preferably 15% or more, more preferably 18% or more, particularly preferably 20% or more. When the breaking elongation is less than 15%, process-passing properties in after-processing steps such as spinning unfavorably deteriorate.

In the present invention, the “breaking elongation” of the meta-type wholly aromatic polyamide fiber can be controlled by forming a dense coagulation state having no skin-core structure in a coagulation step in a production process described later. In order to adjust the breaking elongation to 15% or more, an aqueous solution of an amide-based solvent (for example, NMP (N-methyl-2-pyrrolidone)) having a concentration of 45 to 60% by mass may be used as a coagulation liquid, and the temperature of the bath liquid may be adjusted to 10 to 50° C.

Incidentally, the term “breaking elongation” as used herein means the value obtained by performing measurement, based on JIS L 1015, under the above-mentioned measuring conditions of the “breaking strength.”

[Dry Heat Shrinkage Percentage at 300° C.]

Further, the meta-type wholly aromatic polyamide fiber of the present invention has a dry heat shrinkage percentage at 300° C. of preferably 5.0% or less, more preferably within the range of 1.0 to 4.0%. In the case where the dry heat shrinkage percentage at 300° C. is high, shrinkage of the fiber occurs when a fiber structure formed is exposed to high temperature, so that it becomes difficult to design the fiber structure. The above-mentioned dry heat shrinkage percentage is preferably about 0.1 to 3%.

In order to decrease the above-mentioned dry heat shrinkage percentage at 300° C. to 5.0% or less in the meta-type wholly aromatic polyamide fiber of the present invention, the heat treatment temperature in a heat stretching step in a production process described later may be adjusted to the range of 310 to 335° C. Less than 310° C. results in an increase in dry heat shrinkage percentage, whereas exceeding 335° C. results in a decrease in strength and the occurrence of coloration due to heat deterioration of the polymer.

Incidentally, the term “dry heat shrinkage percentage at 300° C.” in the present invention means the value obtained by the following method.

(Measuring Method of Dry Heat Shrinkage Percentage at 300° C.)

A load of 98 cN (100 g) is hung from one end of a tow of about 3,300 dtex, and marks are put on positions 30 cm apart from each other. After removal of the load, the tow is placed under an atmosphere of 300° C. for 15 minutes, and then, the length L (cm) between the marks is measured. The value obtained by the following equation based on the measurement result L (cm) is taken as the dry heat shrinkage percentage at 300° C.

Dry heat shrinkage percentage at 300° C. (%)=[(30-L)/30]×100

[Initial Elastic Modulus]

Furthermore, the meta-type wholly aromatic polyamide fiber of the present invention has an initial elastic modulus of preferably 800 to 1,500 cN/mm², more preferably within the range of 900 to 1,500 cN/mm². When the initial elastic modulus is within the range of 800 to 1,500 cN/mm², the fiber structure formed becomes difficult to deform by external force. Accordingly, when it is used for a base fabric of a non-woven fabric and the like, it becomes easy to secure dimensional accuracy.

In order to adjust the above-mentioned initial elastic modulus to 800 to 1,500 cN/mm² in the meta-type wholly aromatic polyamide fiber of the present invention, plastic stretching may be performed at a ratio within the range of 3.5 to 10.0 times in a plastic stretching step of a production process described later. When the stretching ratio is less than 3.5 times, the initial elastic modulus does not reach the desired value. On the other hand, when the ratio is higher than 10.0 times, yarn breakage frequently occurs, resulting in deterioration of process performance.

Incidentally, the term “initial elastic modulus” as used herein means the value obtained by performing measurement, based on JIS L 1015, under the above-mentioned measuring conditions of the “breaking strength.”

[Cross-Sectional Shape and Fineness of Monofilament]

Incidentally, the cross-sectional shape of the meta-type wholly aromatic polyamide fiber of the present invention may be a circular shape, an elliptical shape or other arbitrary shapes, and generally, the fineness of a monofilament (monofilament fineness) is preferably within the range of 0.5 to 10.0 dtex.

Further, the meta-type wholly aromatic polyamide fiber of the present invention is obtained by wet spinning using a spinning die having a number of spinning holes, and obtained, for example, as a tow of 200 to 70, 000 dtex through 100 to 30,000 holes per spinning die, preferably 2,000 to 45,000 dtex through 1,000 to 20,000 holes per spinning die.

[Constitution of Meta-Type Wholly Aromatic Polyamide]

A meta-type wholly aromatic polyamide constituting the meta-type wholly aromatic polyamide fiber of the present invention is composed of a meta-type aromatic diamine component and a meta-type aromatic dicarboxylic acid component, and another copolymerizable component such as a para-type may be copolymerized within the range not impairing the object of the present invention.

Particularly preferably used in the present invention is a meta-type wholly aromatic polyamide mainly composed of m-phenylene isophthalamide units, from the viewpoints of mechanical characteristics, heat resistance and flame retardancy.

As the meta-type wholly aromatic polyamide composed of m-phenylene isophthalamide units, the m-phenylene isophthalamide units are contained in an amount of preferably 90 mol % or more, more preferably 95 mol % or more, particularly preferably 100 mol %, based on the whole repeating units.

[Raw Materials for Meta-Type Wholly Aromatic Polyamide]

(Meta-Type Aromatic Diamine Component)

As the meta-type aromatic diamine components used as raw materials for the meta-type wholly aromatic polyamide, there can be exemplified m-phenylenediamine, 3,4′-diaminodiphenyl ether, 3,4′-diaminodiphenyl sulfone and the like, and derivatives thereof in which an aromatic ring thereof has a substituent such as halogen or an alkyl group having 1 to 3 carbon atoms, for example, 2,4-tolylenediamine, 2, 6-tolylene-diamine, 2,4-diaminochlorobenzene, 2,6-diaminochlorobenzene or the like. Above all, preferred is m-phenylenediamine alone or a mixed diamine containing m-phenylenediamine in an amount of 85 mol % or more, preferably 90 mol % or more, particularly preferably 95 mol % or more.

(Meta-Type Aromatic Dicarboxylic Acid Component)

Raw materials for the meta-type aromatic dicarboxylic acid component constituting the meta-type wholly aromatic polyamide include, for example, meta-type aromatic dicarboxylic acid dihalides. As the meta-type aromatic dicarboxylic acid dihalides, there can be exemplified isophthalic acid dihalides such as isophthaloyl chloride and isophthaloyl bromide, and derivatives thereof in which an aromatic ring thereof has a substituent such as halogen or an alkyl group having 1 to 3 carbon atoms, for example, 3-chloroisophthaloyl chloride and the like. Above all, preferred is isophthaloyl chloride itself or a mixed carboxylic acid halide containing isophthaloyl chloride in an amount of 85 mol % or more, preferably 90 mol % or more, particularly preferably 95 mol % or more.

The meta-type wholly aromatic polyamide fiber of the present invention contains substantially no layered clay mineral. The term “containing substantially no layered clay mineral” means that when the meta-type wholly aromatic polyamide and the meta-type wholly aromatic polyamide fiber are produced, no layered clay mineral is intentionally added. Although the concentration thereof is not particularly specified, it is, for example, 0.01% by mass or less, preferably 0.001% by mass or less, and more preferably 0.0001% by mass or less.

[Production Method of Meta-Type Wholly Aromatic Polyamide]

A production method of the meta-type wholly aromatic polyamide is not particularly limited, and it can be produced, for example, by solution polymerization, interfacial polymerization or the like using the meta-type aromatic diamine component and the meta-type aromatic dicarboxylic acid dichloride component as the raw materials.

Incidentally, the molecular weight of the meta-type wholly aromatic polyamide used in the present invention is not particularly limited, as long as it is on a fiber-formable level . In general, in order to obtain the fiber having sufficient physical properties, a polymer having an intrinsic viscosity (I.V.) ranging from 1.0 to 3.0, which is measured in concentrated sulfuric acid at a polymer concentration of 100 mg/100 mL sulfuric acid at 30° C., is suitable, and a polymer having an intrinsic viscosity ranging from 1.2 to 2.0 is particularly preferred.

<Production Method of Meta-Type Wholly Aromatic Polyamide Fiber>

The meta-type wholly aromatic polyamide fiber of the present invention is produced by using the aromatic polyamide obtained by the above-mentioned production method, for example, through a spinning solution preparation step, a spinning-coagulation step, a plastic stretching bath stretching step, a rinsing step, a dry heat treatment step and a heat stretching step which are described below.

[Spinning Solution Preparation Step]

In the spinning solution preparation step, the meta-type wholly aromatic polyamide is dissolved in an amide-based solvent to prepare a spinning solution (meta-type wholly aromatic polyamide polymer solution). In the preparation of the spinning solution, the amide-based solvent is usually used. As the amide-based solvent used, there can be exemplified N-methyl-2-pyrrolidone (NMP), dimethylformamide (DMF), dimethylacetamide (DMAc) or the like. Of these, from the viewpoints of solubility and handling safety, it is preferred to use NMP or DMAc.

As for the solution concentration, from the viewpoints of the coagulation speed in the spinning-coagulation step as the subsequent step and solubility of the polymer, a proper concentration may be appropriately selected. For example, when the polymer is the meta-type wholly aromatic polyamide such as poly-m-phenylene isophthalamide and the solvent is the amide-based solvent such as NMP, it is usually preferably within the range of 10 to 30% by mass.

[Spinning-Coagulation Step]

In the spinning-coagulation step, the spinning solution (meta-type wholly aromatic polyamide polymer solution) obtained above is spun into a coagulation liquid to coagulate it.

A spinning apparatus is not particularly limited, and a conventionally known wet-spinning apparatus can be used. Further, it is unnecessary to particularly limit the number of spinning holes, the arranged state thereof, the hole shape and the like of the spinning die, as long as wet spinning can be stably performed. For example, there may be used a multi-hole spinning die for staple fiber having 1,000 to 30,000 holes and a spinning hole diameter of 0.05 to 0.2 mm.

Further, the temperature of the spinning solution (meta-type wholly aromatic polyamide polymer solution) at the time when it is spun from the spinning die is suitably from 20 to 90° C.

As a coagulation bath used for obtaining the fiber of the present invention, there is used a substantially inorganic salt-free amide-based solvent, preferably an aqueous solution having an NMP concentration of 45 to 60% by mass, at a bath liquid temperature ranging from 10 to 50° C. When the concentration of the amide-based solvent (preferably NMP) is less than 45% by mass, a structure having a thick skin is formed to decrease the rinsing efficiency in the rinsing step. It becomes therefore difficult to decrease the amount of the residual solvent in the fiber. On the other hand, when the concentration of the amide-based solvent (preferably NMP) exceeds 60% by mass, the inside of the fiber cannot be uniformly coagulated. For this reason, it also becomes difficult to decrease the amount of the residual solvent in the fiber. Incidentally, the time of immersion of the fiber in the coagulation bath is suitably within the range of 0.1 to 30 seconds.

It is preferred that the substantially salt-free coagulation solution as used herein is substantially composed of only the amide-based solvent and water. However, inorganic salts such as calcium chloride and calcium hydroxide are extracted from the polymer solution, so that actually, these salts are contained in the coagulation solution in small amounts.

The suitable concentration of the inorganic salts in industrial practice is within the range of 0.3 to 10% by mass based on the whole coagulation solution. It is unsuitable to decrease the inorganic salt concentration to less than 0.3% by mass, because the recovering cost for purification in a recovering process of the coagulation solution extremely increases. On the other hand, when the inorganic salt concentration exceeds 10% by mass, fusion of fibers immediately after extrusion from the spinning die is liable to occur due to the decreased coagulation speed, and coagulation equipment necessarily becomes large due to the prolonged coagulation time. This is therefore unfavorable.

In the present invention, the skin formed on a surface of the fiber can be thinned to form a uniform structure in the inside of the fiber, and further, the braking elongation of the resulting fiber can be improved, by setting the components or conditions of the coagulation bath as described above.

By such a spinning-coagulation step, the fiber (tow) composed of a coagulated yarn of the porous meta-type wholly aromatic polyamide is formed in the coagulation bath, and thereafter, taken out from the coagulation bath into the air.

[Plastic Stretching Bath Stretching Step]

In the plastic stretching bath stretching step, the fiber is stretched in a plastic stretching bath, while the fiber obtained by coagulation in the coagulation bath is in a plastic state. The plastic stretching bath is not particularly limited, and conventionally known one can be employed.

For example, an aqueous solution comprising an aqueous solution of an amide-based solvent and containing substantially no salt can be used. Industrially, it is particularly preferred to use a solvent of the same kind as used in the above-mentioned coagulation bath. That is to say, the amide solvents used in the polymer solution, the coagulation bath and the plastic stretching bath are preferably the same kind, and a sole solvent of N-methyl-2-pyrrolidone (NMP) or a mixed solvent comprising two or more including NMP is particularly preferably used. By using the amide solvents of the same kind, the recovering steps can be integrated and simplified, which becomes economically useful.

There is a close relationship between the temperature and the composition of the plastic stretching bath, and it can be suitably used when the mass concentration of the amide-based solvent is within the range of 20 to 70% by mass and the temperature is within the range of 20 to 70° C. In a region lower than these ranges, plasticization of the porous fibrous material does not sufficiently proceed, and it becomes difficult to take a sufficient stretching ratio in plastic stretching. On the other hand, in a region higher than these ranges, the surface of the porous fiber is melted and fused, so that it becomes difficult to sufficiently form the fiber.

In order to obtain the fiber of the invention, it is necessary to adjust the stretching ratio in the plastic stretching bath to the range of 3.5 to 10.0 times, more preferably to the range of 4.0 to 6.5 times. In the present invention, stretching in the plastic stretching bath is performed within the above-mentioned range to increase the molecular chain orientation due to stretching, thereby being able to secure the strength of the fiber finally obtained.

When the stretching ratio in the plastic stretching bath is less than 3.5 times, it becomes difficult to obtain the fiber having a breaking strength of 5.0 cN/dtex or more. On the other hand, when the stretching ratio exceeds 10.0 times, monofilament breakage occurs, resulting in poor production stability.

The temperature of the plastic stretching bath is preferably within the range of 20 to 90° C. When the temperature is within the range of 20 to 90° C., it is preferred because of good process performance. The above-mentioned temperature is more preferably from 20 to 60° C.

[Rinsing Step]

In the rinsing step, the fiber stretched in the plastic stretching bath is thoroughly rinsed. The rinsing has an influence on quality of the fiber obtained, so that it is preferably performed in multiple stages. In particular, the temperature of a rinsing bath and the concentration of the amide-based solvent in a rinsing bath liquid in the rinsing step exert an influence on an extracted state of the amide-based solvent from the fiber and an entering state of water from the rinsing bath into the fiber. Accordingly, also for the purpose of optimizing these states, it is preferable that the rinsing step is performed in multiple stages to control temperature conditions and concentration conditions of the amide-based solvent.

The temperature conditions and the concentration conditions of the amide-based solvent are not particularly limited, as long as they can satisfy the quality of the fiber finally obtained. However, when the first rinsing bath is set to a high temperature of 60° C. or more, water enters the fiber at once. Accordingly, large voids are formed in the fiber to cause deterioration of the quality. For this reason, the first rinsing bath is preferably set to a low temperature of 30° C. or less.

When the solvent is remained in the fiber, coloration or discoloration (particularly yellowing) under high temperatures cannot be inhibited, and further, deterioration in physical properties, contraction, a decrease in limiting oxygen index (LOI) and the like occur. Accordingly, it is necessary to decrease the amount of the solvent contained in the fiber of the present invention to 1.0% by mass or less, more preferably to 0.5% by mass or less.

[Dry Heat Treatment Step]

In order to obtain the fiber of the present invention, the dry heat treatment step is preferably performed to the fiber which has passed through the above-mentioned rinsing step. In the dry heat treatment step, the fiber which has been rinsed by the above-mentioned rinsing step is subjected to dry heat treatment preferably within the range of 100 to 250° C., more preferably within the range of 100 to 200° C. Here, the dry heat treatment is not particularly limited. However, it is preferably performed under constant length.

When the dry heat treatment is successively performed after the rinsing step, fluidity of the polymer is moderately improved to allow orientation to proceed, whereas to inhibit crystallization, thereby being able to promote densification of the fiber. Incidentally, the above-mentioned temperature of the dry heat treatment means the set temperature of a fiber heating means such as a hot plate or a heating roller.

[Heat Stretching Step]

In the present invention, the heat stretching step is performed to the fiber which has passed through the above-mentioned dry heat treatment step. In the heat stretching step, stretching of 1.1 to 1.8 times is performed while applying heat treatment at 310 to 335° C. When the heat treatment temperature in the heat stretching step is such a high temperature as exceeding 335° C., the yarn colors and significantly deteriorates, resulting in not only a decrease in strength, but also breakage in some cases. On the other hand, at a temperature lower than 310° C., sufficient crystallization of the fiber cannot be attained, and it becomes difficult to exhibit desired fiber physical properties, that is to say, mechanical characteristics such as braking strength and heat characteristics.

There is a close relationship between the treatment temperature in the heat stretching step and the density of the resulting fiber. In order to obtain a product having a particularly good density of the fiber, the heat treatment temperature in the heat stretching step is preferably adjusted to the range of 310 to 335° C. By adjusting the heat treatment temperature in the heat stretching step to the range of 310 to 335° C., the fiber having a dry heat shrinkage percentage at 300° C. of 5.0% or less can be obtained. Incidentally, it is particularly preferred that the heat treatment is dry heat treatment, and the heat treatment temperature in the heat stretching step means the set temperature of a fiber heating means such as a hot plate or a heating roller.

Further, the stretching ratio in the heat stretching step has a close relationship to exhibition of the strength and elastic modulus of the resulting fiber. In order to obtain the fiber of the present invention, the stretching ratio is required to be set usually to 1.1 to 1.8 times, preferably to 1.1 to 1.5 times. By setting the stretching ratio to the above-mentioned range, the strength and elastic modulus to be required can be exhibited, while retaining good heat stretching properties.

[Uses of Meta-Type Wholly Aromatic Polyamide Fiber]

The meta-type wholly aromatic polyamide fiber of the present invention is subjected to crimping processing or the like as needed, cut to an appropriate fiber length, and provided to a subsequent step of spinning or the like.

Thus, the meta-type wholly aromatic polyamide fiber of the present invention can be applied to various uses taking advantages of its heat resistance, flame retardancy and mechanical characteristics. For example, woven and knitted fabrics of the fiber of the present invention alone or in combination with another fiber can be used as heat-resistant flame-retardant clothing materials such as fireman uniforms and protective garments, and flame-retardant bedclothes and interior materials. Further, as nonwoven fabrics, it can also be effectively used as various industrial materials such as filters, or as raw materials for synthetic paper and composite materials.

Especially, the meta-type wholly aromatic polyamide fiber of the present invention maintains a high strength and can inhibit coloration or discoloration of the products even when processed and used under high temperatures. Accordingly, it is particularly useful for uses used in a state exposed to high temperatures, for example, as materials for base fabrics of felts for high temperature, filters for high-temperature gas, and the like, or as matrix reinforcement materials for rubbers, resins and the like, taking advantage of high elastic modulus.

### EXAMPLES

The present invention will be described below in more detail with reference to examples and the like, but should not be construed as being limited by these examples and the like. Incidentally, “parts” and “%” are by mass, unless otherwise specified, and “amount ratio” indicates “mass ratio,” unless otherwise specified. Further, the polymer concentration (PN concentration) in the polymer solution (spinning stock solution) used for spinning is “% by mass of the polymer” based on “the whole parts by mass,” that is to say, [polymer/(polymer+solvent+others)]×100 (%).

<Measuring Methods>

Respective values of the physical properties in Examples and Comparative Examples were measured by the following methods.

[Intrinsic Viscosity (IV)]

The aromatic polyamide polymer was isolated from the polymer solution and dried, and measurement was made in concentrated sulfuric acid at a polymer concentration of 100 mg/100 mL sulfuric acid at 30° C.

[Monofilament Fineness]

Measurement based on method A of conditioned fineness was made according to JIS L 1015, and the fineness was indicated by apparent fineness.

[Breaking Strength, Breaking elongation and Initial Elastic Modulus]

Measurement was made based on JIS L 1015, using a tensile measuring instrument (manufactured by Instron Corp., model number 5565), under the following conditions:

(Measuring Conditions)

Clamp distance: 20 mm

Initial tension: 0.044 cN (1/20 g)/dtex

Tensile speed: 20 mm/min

[Amount of Solvent Remaining in Fiber (Residual Solvent Amount)]

The fiber was sampled at an exit side of the rinsing step. Then, the fiber was centrifuged (number of revolutions: 5,000 rpm) for 10 minutes, and the fiber mass (M1) at this time was measured. This fiber was boiled in M2 g by mass of methanol for 4 hours to extract the amide-based solvent and water in the fiber. The fiber after extraction was dried under an atmosphere of 105° C. for 2 hours, and the fiber mass (P) after drying was measured. Further, the mass concentration (C) of the amide-based solvent contained in an extract was determined with a gas chromatograph.

The amount of solvent remaining in the fiber (amide-based solvent mass) N % was calculated by the following equation, using M1, M2, P and C described above.

N=[C/100]×[(M1+M2−P)/P]×100

[Dry Heat Shrinkage Percentage at 300° C.]

A load of 98 cN (100 g) was hung from one end of a tow of about 3,300 dtex, and marks were put on positions 30 cm apart from each other. After removal of the load, the tow was placed under an atmosphere of 300° C. for 15minutes, and then, the length L (cm) between the marks is measured. The value obtained by the following equation based on the measurement result L (cm) was taken as the dry heat shrinkage percentage at 300° C.

Dry heat shrinkage percentage at 300° C. (%)=[(30-L)/30]×100

[Hue Value (L*−b*)]

The hue value was measured for the resulting fiber and the fiber after heat treated in a drier of 250° C. for 100 hours. Specifically, measurement was made by using a color measuring instrument (manufactured by Macbeth Co., Ltd., trade name: Macbeth Color Eye Model CE-3100) under the following measurement conditions to determine a change in hue value (L*−b*). The lower hue value (L*−b*) indicates the more significant yellowing. Incidentally, L* and b* are obtained by tristimulus values defined in JIS Z 8728 (the indication method of color by the 10-degree visual field XYZ system).

(Measuring Conditions)

Visual field: 10 degrees

Light source: D65

Wavelength: 360 to 740 nm

### Example 1

[Preparation Step of Spinning Stock Solution (Spinning Dope)]

A poly-m-phenylene isophthalamide powder (20.0 parts) having an intrinsic viscosity of 1.9, which was produced by an interfacial polymerization method in accordance with the method described in JP-B-47-10863 was suspended in 80.0 parts of N-methyl-2-pyrrolidone (NMP) cooled to -10° C. to a slurry form. Successively, it was dissolved by rising the temperature of the suspension to 60° C. to obtain a transparent polymer solution.

[Spinning Step]

The resulting polymer solution was extruded as a spinning stock solution into a coagulation bath having a bath temperature of 40° C. through a spinning die having a hole diameter of 0.07 mm and a hole number of 1,500 to perform spinning. The composition of the coagulation bath was water/NMP (amount ratio)=45/55, and the polymer solution was extruded into the coagulation bath at a yarn speed of 7 m/min to perform spinning.

[Plastic Stretching Step]

Successively, stretching was performed in a plastic stretching bath having a temperature of 40° C. and a composition of water/NMP (amount ratio)=40/60 at a stretching ratio of 5.0 times.

[Rinsing Step]

After stretching, the fiber was in turn allowed to pass through a bath (immersion length: 1.8 m) of water/NMP (amount ratio)=70/30 of 20° C., subsequently, a water bath (immersion length: 3.6 m) of 20° C., a hot water bath (immersion length: 5.4 m) of 60° C. and further, a hot water bath (immersion length: 3.6 m) of 80° C. to perform sufficient rinsing.

[Dry Heat Treatment Step]

Successively, dry heat treatment was performed to the fiber after rinsing, with a heat roller having a surface temperature of 150° C. under constant length.

[Heat Stretching Step]

Successively, the heat stretching step in which the fiber was stretched to 1.3 times was performed while applying heat treatment with a heat roller having a surface temperature of 330° C. to finally obtain a poly-m-phenylene isophthalamide fiber.

[Measurements and Evaluations]

Various measurements and evaluations were made for the resulting fiber (tow). The fineness was 2.1 dtex, the breaking strength was 5.5 cN/dtex, the breaking elongation was 24.0%, and all indicated good numerical values. Further, the residual solvent amount in the fiber was 0.4%, the dry heat shrinkage percentage at 300° C. was 3.9%, and the initial elastic modulus was 1,250 cN/mm². These showed excellent heat shrinkage stability. The results obtained are shown in Table 1.

### Example 2

A poly-m-phenylene isophthalamide fiber was produced in the same manner as in Example 1 with the exception that the solvent used in the preparation step of a spinning stock solution (spinning dope) was changed to N,N-dimethylacetamide (DMAc) to produce a polymer solution, which was used as the spinning stock solution. The results of various measurements for the resulting fiber are shown in Table 1.

### Comparative Example 1

A poly-m-phenylene isophthalamide fiber was produced in the same manner as in Example 1 with the exception that the composition of the coagulation liquid was changed to water/NMP (amount ratio)=70/30 in the coagulation step. The results of various measurements for the resulting fiber are shown in

Table 1.

### Comparative Example 2

A poly-m-phenylene isophthalamide fiber was obtained in the same manner as in Example 1 with the exception that the stretching ratio in the heat stretching step was changed to 1.0 time. The results of various measurements for the resulting fiber are shown in Table 1.

### Example 3

[Preparation Step of Spinning Stock Solution (Spinning Dope)]

Into a reaction vessel under an atmosphere of dry nitrogen, 721.5 parts of NMP having a moisture content of 100 ppm or less was weighed, and 97.2 parts (50.18 mol %) of m-phenylenediamine was dissolved in this NMP, followed by cooling to 0° C. To this cooled NMP solution, 181.3 parts (49.82 mol %) of isophthaloyl chloride (hereinafter, abbreviated as “IPC”) was further gradually added with stirring to perform a polymerization reaction. Incidentally, after changes in viscosity stopped, stirring was continued for 40 minutes to complete the polymerization reaction.

Then, 66.6 parts of a calcium hydroxide powder having an average particle size of 10 μm or less was weighed, and slowly added to the polymer solution in which the polymerization reaction was completed to conduct a neutralization reaction. After the introduction of calcium hydroxide was completed, stirring was further performed for 40 minutes to obtain a transparent polymer solution.

Poly-m-phenylene isophthalamide was isolated from the resulting polymer solution, and the IV thereof was measured. As a result, it was 1.25. Further, the polymer concentration in the polymer solution was 20%.

[Spinning Step, Plastic Stretching Step, Multistage Rinsing Step, Dry Heat Treatment Step and Heat Stretching Step]

A poly-m-phenylene isophthalamide fiber was obtained in the same manner as in Example 1 with the exceptions that the resulting polymer solution was used as the spinning stock solution, that the yarn speed in the spinning step was changed to 5 m/min, and that the stretching ratio in the plastic stretching bath in the plastic stretching step was changed to 6.5 times. The results of various measurements for the resulting fiber are shown in Table 1.

### Example 4

A polymer solution was produced in the same manner as in Example 3 with the exception that the solvent used in the preparation step of a spinning stock solution (spinning dope) was changed to N,N-dimethylacetamide (DMAc), and a poly-m-phenylene isophthalamide fiber was obtained in the same manner as in Example 1, using the resulting polymer solution as the spinning stock solution. The results of various measurements for the resulting fiber are shown in Table 1.

### Comparative Example 3

A poly-m-phenylene isophthalamide fiber was obtained in the same manner as in Example 3 with the exception that the composition of the coagulation liquid was changed to water/NMP (amount ratio)=30/70 in the coagulation step. The results of various measurements for the resulting fiber are shown in Table 1.

### Comparative Examples 4 and 5

Poly-m-phenylene isophthalamide fibers were obtained in the same manners as in Example 3 and Example 4, respectively, with the exception that the stretching ratio in the heat stretching step was changed to 1.0 time. The results of various measurements for the resulting fibers are shown in Table 1.

TABLE 1

| | | | | | Comparative | Comparative | Comparative | Comparative | Comparative |
|---|---|---|---|---|---|---|---|---|---|
| | Example 1 | Example 2 | Example 3 | Example 4 | Example 1 | Example 2 | Example 3 | Example 4 | Example 5 |
| Polymer Dissolution Amide-- | NMP | DMAc | NMP | DMAc | NMP | NMP | NMP | NMP | DMAc |
| Based Solvent | | | | | | | | | |
| Coagulation Bath Amide-- | 45/55 | 45/55 | 45/55 | 45/55 | 70/30 | 45/55 | 30/70 | 45/55 | 45/55 |
| Based Solvent Composition | | | | | | | | | |
| (water/solvent) | | | | | | | | | |
| Plastic Stretching Ratio | 5.0 | 5.0 | 6.5 | 6.5 | 5.0 | 5.0 | 6.5 | 6.5 | 6.5 |
| (times) | | | | | | | | | |
| Heat Stretching Temperature | 330 | 330 | 330 | 330 | 330 | 330 | 330 | 330 | 330 |
| (° C.) | | | | | | | | | |
| Heat Stretching Ratio | 1.3 | 1.3 | 1.3 | 1.3 | 1.3 | 1.0 | 1.3 | 1.0 | 1.0 |
| (times) | | | | | | | | | |
| Fineness (dtex) | 2.1 | 2.2 | 2.1 | 2.2 | 2.1 | 2.2 | 2.1 | 2.3 | 2.2 |
| Breaking Strength (cN/dtex) | 5.5 | 5.7 | 6.0 | 5.8 | 3.0 | 3.7 | 2.9 | 2.7 | 2.9 |
| Breaking Elongation (%) | 24.0 | 20.5 | 18.5 | 18.9 | 14.0 | 28.5 | 35.0 | 18.0 | 20.5 |
| Residual Solvent Amount (%) | 0.4 | 0.2 | 0.1 | 0.08 | 1.4 | 0.9 | 2.5 | 0.3 | 0.3 |
| Dry Heat Shrinkage Percent- | 3.9 | 2.8 | 3.9 | 3.6 | 5.2 | 3.5 | 5.5 | 2.7 | 2.8 |
| age at 300° C. (%) | | | | | | | | | |
| Initial Elastic Modulus | 1250 | 990 | 1170 | 1180 | 890 | 770 | 650 | 710 | 650 |
| (cN/mm²) | | | | | | | | | |
| Before Heat Treatment | 79.7 | 79.5 | 79.0 | 78.9 | 72.1 | 78.5 | 71.1 | 78.3 | 77.8 |
| Hue (L*-b*) | | | | | | | | | |
| After Heat Treatment at | 77.1 | 77.8 | 78.5 | 77.7 | 67.6 | 76.3 | 66.2 | 75.8 | 73.7 |
| 250° C. | | | | | | | | | |
| Hue (L*-b*) | | | | | | | | | |

### INDUSTRIAL APPLICABILITY

According to the present invention, there is provided a meta-type wholly aromatic polyamide fiber (particularly a poly-m-phenylene isophthalamide-based fiber) which is good in mechanical characteristics, heat resistance and the like, has an extremely slight amount of solvent remaining in the fiber, and contains substantially no layered clay mineral. For this reason, fiber products using the meta-type wholly aromatic polyamide fiber of the present invention can inhibit coloration or discoloration while retaining strength even when processed and used under high temperatures. Accordingly, the meta-type wholly aromatic polyamide fiber of the present invention has a high usefulness particularly in fields in which it is processed or used at high temperatures.

1. A meta-type wholly aromatic polyamide fiber containing substantially no layered clay mineral, in which the amount of solvent remaining in the fiber is 1.0% by mass or less based on the whole fiber, and the breaking strength of the fiber is from 4.5 to 6.0 cN/dtex.

2. The meta-type wholly aromatic polyamide fiber according to claim 1, wherein the fiber has a dry heat shrinkage percentage at 300° C. of 5.0% or less.

3. The meta-type wholly aromatic polyamide fiber according to claim 1, wherein the fiber has an initial elastic modulus of 800 to 1,500 cN/mm².

4. The meta-type wholly aromatic polyamide fiber according to claim 2, wherein the fiber has an initial elastic modulus of 800 to 1,500 cN/mm².
